(19) United States
(12) Patent Application Publication
(10) Pub. No.: US 2006/0043239 A1
(43) Pub. Date: Mar. 2, 2006

(54) Method for detecting and repairing scratches and cracks proximate aircraft fuselage lap joints

(76) Inventors: Joseph F. Floyd, University Place, WA (US); John R. Linn, Maple Valley, WA (US)

Correspondence Address: INGRASSIA FISHER & LORENZ, P.C., 7150 E. CAMELBACK, STE. 325, SCOTTSDALE, AZ, 85251, US

(21) Appl. No.: 10/928,543

(22) Filed: Aug. 26, 2004

(51) Int. Cl. B64C 1/06

(52) U.S. Cl. 244/131

(57) ABSTRACT

A method for detecting scratches proximate an aircraft lap joint formed where an outer skin panel overlaps an inner panel comprises trimming a portion of the outer skin panel overlapping the inner panel to expose a previously overlapped region thereof, and inspecting the previously overlapped region to detect scratches present thereon.

### FIELD OF THE INVENTION

The present invention relates generally to a method for detecting and repairing scratches and cracks located proximate aircraft lap joints formed by overlapped fuselage skin panels, and more particularly to a method for detecting and repairing such scratches and cracks in inner panels adjacent lap joints.

### BACKGROUND OF THE INVENTION

Lap joints are created when two or more aircraft skin panels are joined, and a portion of one panel (i.e. an inner panel) is overlapped by portion of another panel (i.e. an outer skin panel). The term lap joint, as used herein, refers both to longitudinal joints, as formed when outer (e.g. an upper longitudinal panel) and inner (e.g. a lower longitudinal panel) fuselage skin panels are joined, and to circumferential or butt joints, as formed when two curved skin panel assemblies are joined by a structural panel (e.g. a splice plate). Similarly, the term inner panel, as used herein, may refer any structural panel (e.g. a splice plate or an inner fuselage skin panel) that is at least partially overlapped at a lap joint. Lap joint panels are typically joined together utilizing an anti-corrosive sealant and a plurality (e.g. two or three) rows of rivets disposed proximate the outer skin panel's overlapping edge.

It has been discovered that the surface of inner panels may be scratched proximate the lap joints during routine maintenance (e.g. during removal of excess lap joint sealant). This is problematic because such scratches may lead to the formation of cracks in panels over time that may structurally compromise the aircraft's fuselage. If cracks have not yet formed, the scratches may be blended out by abrasively removing a shallow volume of material along the panel's surface providing that scratches are visible and accessible and that the scratched skin panel is sufficiently thick. If cracks have formed, however, the cracked panel may require the excision of the cracked portion thereof and the installment of a replacement panel such as a repair doubler. Unfortunately, this is a relatively costly and cumbersome process.

Repair of scratches and cracks on or in the lapped area of an inner panel is further complicated because access thereto is prevented by the overlapping outer skin panel. For this reason, detection of such inner skin cracks and scratches typically requires the use of expensive ultrasonic and subsurface eddy current detection methods as opposed to other, less expensive detection methods (e.g. visual detection for scratches and high frequency eddy current detection for cracks).

It should thus be appreciated that it would be desirable to provide an improved method for detecting and, if necessary, repairing cracks and scratches present in inner aircraft fuselage panels proximate the aircraft's lap joints.

### BRIEF SUMMARY OF THE INVENTION

According to a broad aspect of the invention there is provided a method for detecting scratches proximate an aircraft lap joint formed where an outer skin panel overlaps an inner panel wherein a portion of the outer skin panel overlapping the inner panel is trimmed to expose a previously overlapped region thereof, and the previously overlapped region is inspected to detect scratches.

According to a further aspect of the invention there is provide a method for detecting scratches and cracks proximate an aircraft fuselage lap joint formed where an outer skin panel overlaps an inner panel wherein a portion of the outer skin panel overlapping the inner panel is trimmed to expose a previously overlapped region thereof, and the previously overlapped region is inspected to detect scratches and tested to detect cracks.

According to a still further aspect of the invention there is provided a method for detecting and repairing scratches and cracks proximate an aircraft fuselage lap joint formed where an outer skin panel having an overlapping edge overlaps an inner panel wherein at least a first scratch is found in the inner panel proximate the lap joint, and a portion of the outer skin panel overlapping the inner panel including at least a portion of the overlapping edge is trimmed to expose a previously overlapped region of the inner panel. The previously overlapped region is inspected to detect scratches and tested to detect cracks and at least one detected crack is repaired.

### BRIEF DESCRIPTION OF THE DRAWINGS

The present invention will hereinafter be described in conjunction with the following figures, wherein like numerals denote like elements, and:

FIG. 1 is a plan view of an aircraft fuselage;

FIGS. 2 and 3 are cross-sectional views of a circumferential and a longitudinal lap joint, respectively;

FIGS. 4 and 5 are isometric views of an untrimmed and trimmed longitudinal lap joint of the type depicted in FIG. 3, respectively;

FIG. 6 is a magnified photographic cross-sectional view of the untrimmed lap joint shown in FIG. 4;

FIG. 7 is an isometric view of a lap joint of the type depicted in FIGS. 3-6 and a trimming tool for use thereon;

FIG. 8 is a side view a lap joint of the type depicted in FIGS. 3-7 and an isometric view a high frequency eddy current (HEFC) device for detecting cracks therein;

FIG. 9 is a schematic view illustrating the generation of eddy currents in a test article (e.g. an inner structural panel such as an inner fuselage skin panel) by way of an HFEC device of the type shown in FIG. 8; and

FIG. 10 is a flow chart illustrating an exemplary inventive method for detecting and, if necessary, repairing inner panel cracks and scratches.

### DETAILED DESCRIPTION OF THE INVENTION

The following detailed description of the invention is merely exemplary in nature and is not intended to limit the scope, applicability, or configuration of the invention in any way. Rather, the following description provides a convenient illustration for implementing an exemplary embodiment of the invention. Various changes to the described embodiment may be made in the function and arrangement of the elements described herein without departing from the scope of the invention.

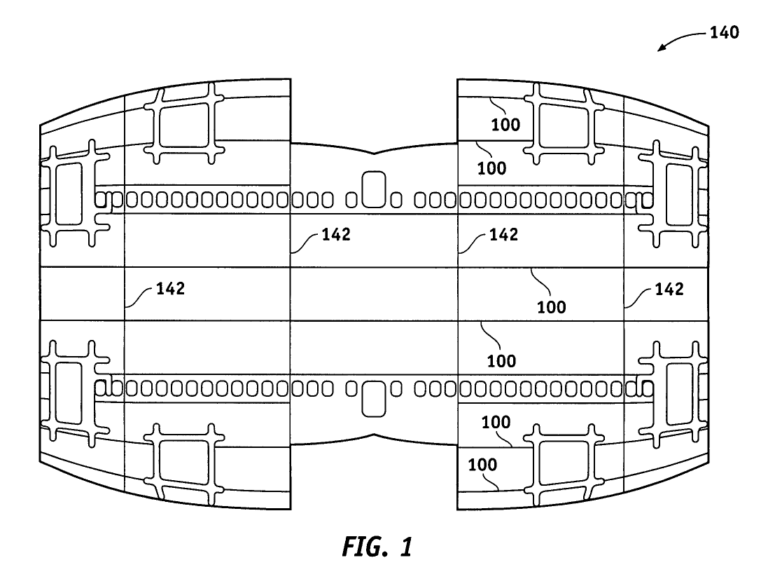

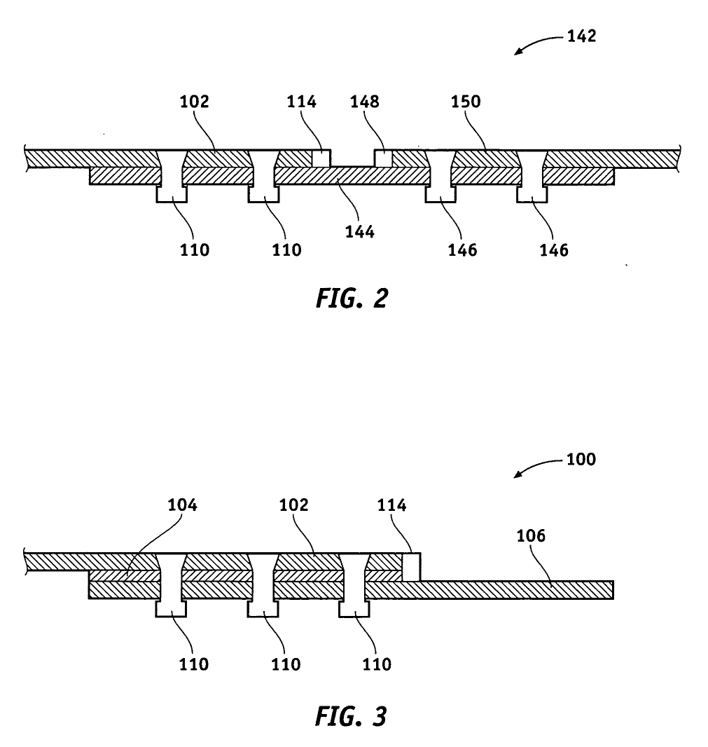

FIG. 1 is a plan view of an aircraft fuselage 140, comprising multiple structural panels (e.g. fuselage skin panels). When coupled together, the panels comprising fuselage 140 are joined utilizing at least two types of joints: circumferential lap joints 142 and longitudinal lap joints 100. Referring to FIG. 2, a circumferential lap joint 142 is formed when first and second outer skin panels 102 and 150, respectively, are coupled by first and second pluralities of rivets 110 and 146, respectively, to an inner structural panel 144 (e.g. a splice plate).

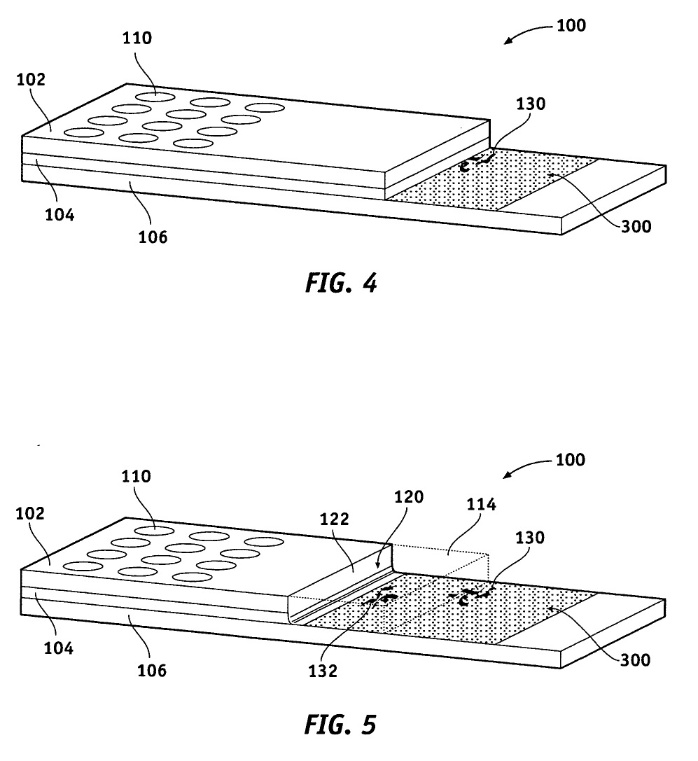

In contrast to circumferential lap joints longitudinal lap joints typically join an outer fuselage skin panel to an inner overlapped fuselage skin panel. A longitudinal lap join 100 is shown in cross-section in FIG. 3 and in an isometric view in FIGS. 4 and 5. Lap joint 100 comprises an outer skin panel 102, a doubler 104, and an inner skin panel 106. Outer skin panel 102 may be bonded by way of an anti-corrosion sealant (not shown in FIGS. 3-5) to doubler 104, which may be, in turn, bonded by way of anti-corrosion sealant (not shown) to inner skin panel 106. Each of these three layers is further coupled together by a plurality of rivets 110 (e.g. three rows of counter-sunk rivets). Outer skin panel 102, bonded doubler 104, and inner panel 106 may be manufactured from a lightweight material (e.g. aluminum) and may have a base metal component comprising an alloy (e.g. aluminum-copper).

Referring to FIGS. 4 and 5, an area 300 (shown exaggerated for clarity) of the outer surface of inner panel 106 is prone to scratching during aircraft maintenance (e.g. during removal of excess sealant). Area 300 is disposed proximate the overlapping edge of lap joint 100 and roughly corresponds to the location of excess sealant that may have been removed during maintenance. When lap joint 100 is untrimmed as shown in FIG. 4, only a portion of surface area 300 may be seen. After lap joint 100 is trimmed as shown in FIG. 5, however, surface area 300 may be seen in its entirety.

A series of scratches 130 (e.g. scribe marks made, perhaps, by a cutting tool used to remove excess sealant) is present on inner surface 106 within surface area 300. Prior to trimming (FIG. 4), scratches 130 are only partially visible. After trimming (FIG. 5), however, scratches 130 are entirely visible. The presence of scratches 130 suggests that inner panel 106 may have additional scratches within or proximate area 300 that are hidden by overlapping edge 114 of outer skin panel 102 and doubler 104. Edge 114 may be trimmed (i.e. removed) without weakening lap joint 100 to reveal area 300 in its entirety and thus permit further inspection thereof. As can be seen in FIG. 5, trimming of edge 114 reveals a second series of scratches 132 that was hidden by overlapping edge 114 prior to trimming.

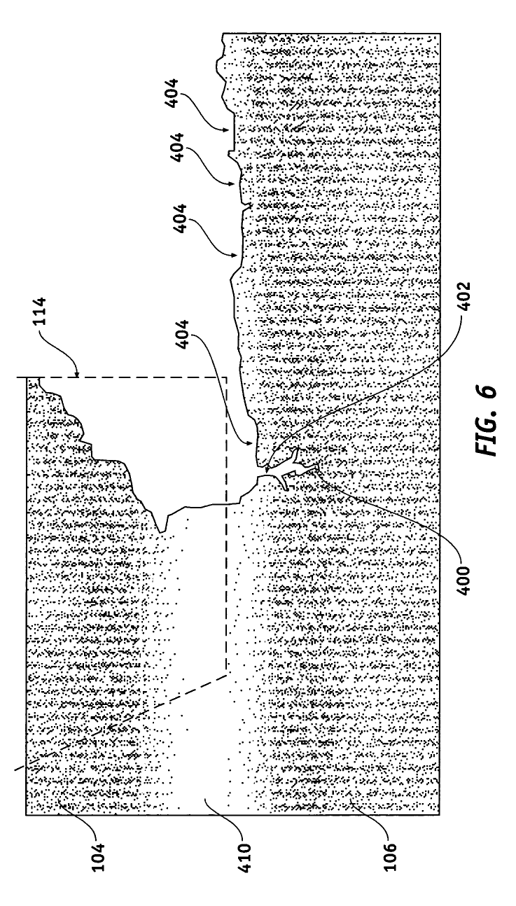

FIG. 6 is a magnified photographic cross-sectional view of lap joint 100. Scratches may initiate the formation of cracks that penetrate into inner panel 106 and weaken lap joint 100. As can be seen, a plurality of scratches 404 including a scratch 402 is present on the outer surface of inner panel 106. A crack 400 has initiated from scratch 402 and extends downward therefrom into inner panel 106. When lap joint 100 is untrimmed (FIG. 4), scratch 402 is hidden from view by overlapping edge 114. Trimming of edge 114, however, may reveal scratch 402.

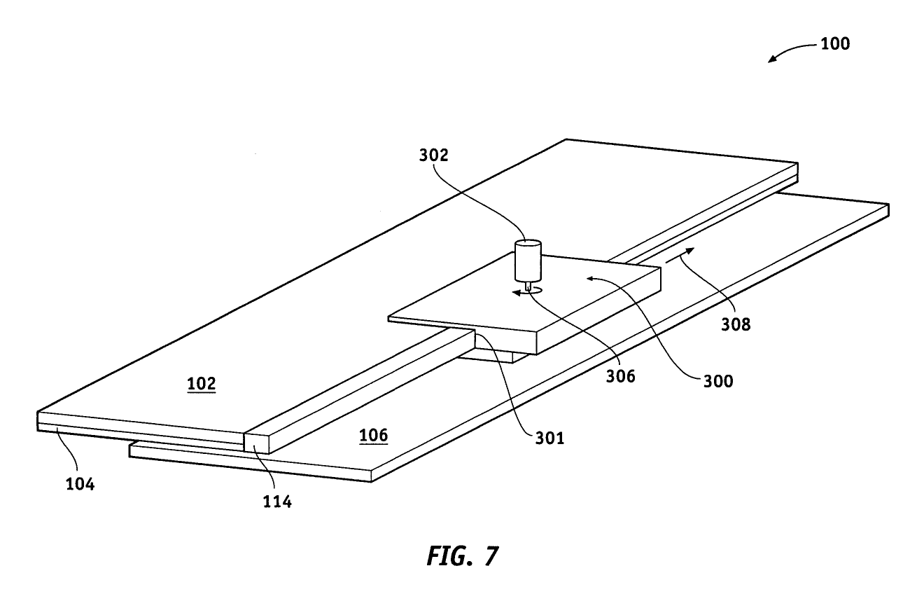

Trimming of edge 114 may be accomplished by the means of a trim tool 300, for example, of the type shown in FIG. 7. Trim tool 300 comprises a handle 302 and a rotary cutting shaft 306 having a distal cutting head (not shown). Trim tool 300 has a guide edge 301 that may be moved along lap joint 100 in the direction of arrow 308 so as to trim edge 114 away from outer skin panel 102 and doubler 104. Cutting shaft 306 is offset from edge 301 and inner panel 106 so as to trim lap joint 100 to a predetermined depth. The trimming depth may be controlled by adjusting the depth of the distal cutting head relative to guiding edge 301. It is desirable that trim tool 300 remove most or all of edge 114 while leaving inner panel 106 unscathed. Generally, trim tool 300 should be of the type capable of trimming 0.070 inch plus or minus 0.010 inch. If preferred, however, trim tool 300 may be configured to leave behind a thin layer of doubler 104 and sealant 410, which can later be removed with a manual scrapping tool (e.g. a nylon scrapper). If preferred, however, trim tool 300 may be configured to trim more then 0.070 inches of the lap joint or less then 0.070 inches of the lap joint edge and leave behind a thin layer of doubler 104 and sealant 410, which can later be removed with a manual scrapping tool (e.g. a nylon scrapper). Trimming of edge 114 may also be accomplished by means of an automated computer controlled machine trim tool rather then a hand operated tooling. The computer controlled trim tool machine may use a laser for trim feed back control of the lap joint edge location and thickness.

Due to the configuration of trim tool 300 (e.g. the tapering of the cutting head), residual material 122 may be left after trimming. The residual material 122 (FIG. 5) may be disposed along the base of edge 120 (FIG. 5) proximate inner panel 106 and may comprise a remnant foil of doubler 104 and, perhaps, outer skin panel 102. To prevent interference with crack detection, residual material 122 (FIG. 5) should be of a relatively small width and thickness (e.g. 0.020 and 0.003 inch, respectively).

After edge 114 has been trimmed away from lap joint 100, the newly exposed section of inner panel 106 including area 300 may be examined for scratches and cracks. Scratches may be detected by, for example, visual observation. Cracks, which may extend further below the surface of skin 106, may be detected using a non-destructive inspection (NDI) method; for example, high frequency eddy current (HFEC) inspection.

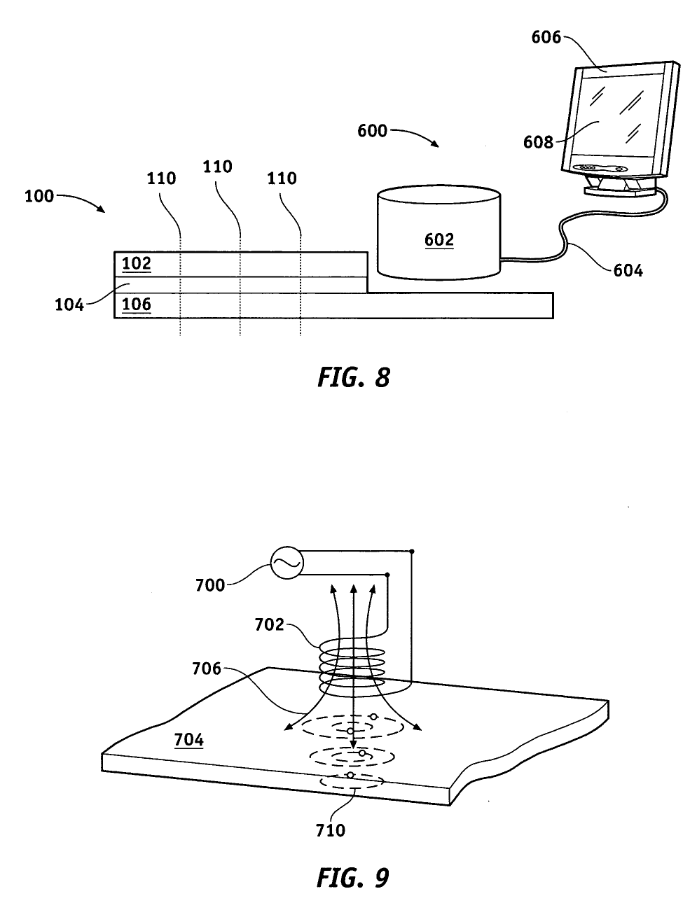

An exemplary HFEC device 600 is illustrated in FIG. 8. HFEC device 600 comprises a probe 602 coupled by way of a connection 604 to an inspection instrument 606 having a display 608. As illustrated in FIG. 9, HFEC device 600 creates eddy currents within an article 704 (e.g. a structural panel such as inner skin panel 106) by delivering thereto an alternating current 700 via a conductive coil/s 702 contained within probe/s 602 (FIG. 8). Alternating current 700 induces an alternating magnetic field 706 in article 704, which, in turn, induces eddy currents 710 to flow therethrough. The strength of eddy currents 710 are measured by probe 602 and the results displayed on display 608. If the observed conductivity is significantly below a predicted value, current-impeding cracks are likely present in the tested article and crack repair may be undertaken.

HFEC inspection devices, such as that just described, are well known and further discussion is not deemed necessary at this time; however, the interested reader is referred generally to U.S. Pat. No. 4,706,020 entitled “High Frequency Eddy Current Probe with Planar, Spiral-like Coil on Flexible Substrate for Detecting Flaws in Semi-Conductive Material” issued to Viertl, et al. on Nov. 10, 1987, and U.S. Pat. No. 3,963,980 entitled “Ultrasonic Instrument for Non-Destructive Testing of Articles with Current-Conducting Surfaces” issued to Shkarlet on Jun. 15, 1976.

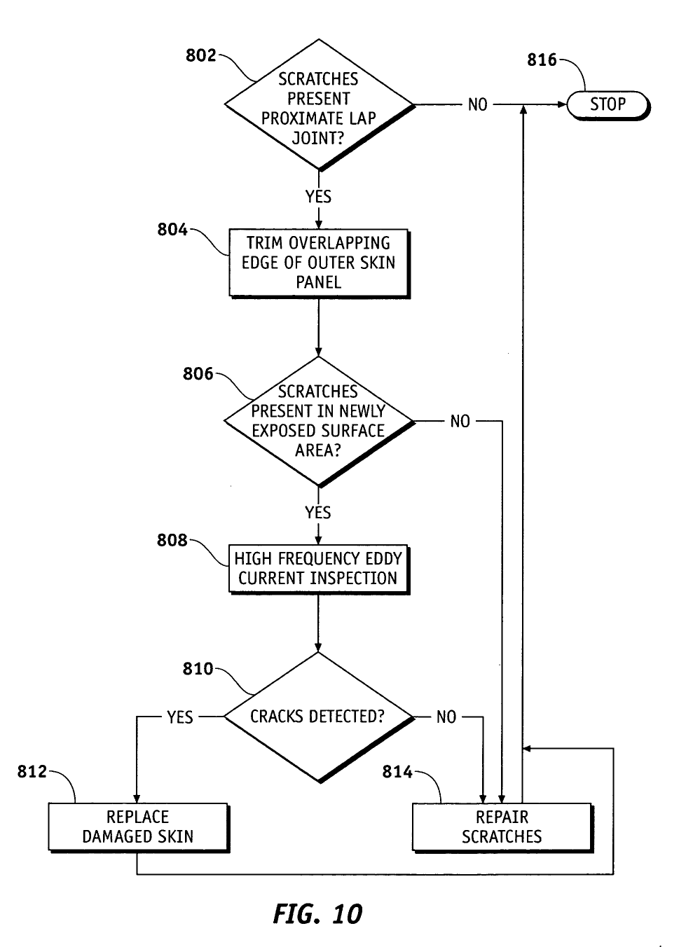

FIG. 10 is a flow chart illustrating an exemplary embodiment of an inventive process for detecting and, if necessary, repairing inner panel (e.g. inner fuselage skin panel) scratches and cracks of the type described above in connection with lap joint 100. To begin, the exposed portion of the inner panel proximate the lap joint may be examined for scratches (802). This may be done, for example, through visual inspection. If no scratches are found on the exposed portion of the inner panel, the process may be halted (816) and no further action taken until the next scheduled inspection. If, however, scratches are found on the exposed inner panel, the outer skin panel may be partially trimmed away in the above described manner (804). An inspection for scratches on the newly exposed area of the inner panel may then be conducted (806). If no scratches are detected on the newly exposed area, the scratches previously detected in the inner panel may be repaired (e.g. blended out) (814) and the process may be halted (816) or re-inspect the scratch locations for crack development at an interval dependant on the airplane landing cycles. Alternatively, if scratches are detected on the newly exposed area, a high frequency eddy current (HFEC) inspection may be performed (as described above) on the inner panel to determine if cracks have formed therein (808). If no cracks are detected, the existing scratches may be repaired (814) and the process may be halted (816). If cracks are detected, the cracked area of the panel may be replaced (812) by way of, for example, a repair doubler and the process may be halted (816).

It should be understood that the exemplary process described in conjunction with FIG. 10 is only suggestive in nature. Other processes comprising steps similar to the exemplary process may be implemented. For example, it may be desirable to replace inner panels that are scratched but not cracked, especially if the scratches are relatively deep. Conversely, if the inner panel is sufficiently thick, it may be possible and desirable to blend out relatively shallow cracks. It should further be understood that repair may not take place immediately after detection as it may be desirable to monitored detected scratches for repair at a later time (e.g. after a predefined number of flight cycles).

It should be appreciated that, although the inventive method has been primarily described above in conjunction with longitudinal lap joint 100, the method may be used to repair cracks and scratches proximate circumferential lap joints as well (e.g. circumferential lap joint 142 of FIG. 2). It will be clear to one skilled in the art that, as circumferential joints generally comprise two overlapping edges (e.g. overlapping edges 114 and 148 shown in FIG. 2), many or all of the steps of the inventive method must be performed twice (once for each overlapping edge) to inspect and, if desired, repair the entire circumferential joint.

While an exemplary embodiment has been presented in the foregoing detailed description, it should be appreciated that a vast number of variations exist. It should also be appreciated that the exemplary embodiment is only an example, and is not intended to limit the scope, applicability, or configuration of the invention in any way. Rather, the foregoing detailed description will provide those skilled in the art with a convenient road map for implementing the exemplary embodiment. It should be understood that various changes can be made in the function and arrangement of elements without departing from the scope of the invention as set forth in the appended claims and the legal equivalents thereof.

1. A method for detecting scratches proximate an aircraft lap joint formed where an outer skin panel overlaps an inner panel, the method comprising:
trimming a portion of the outer skin panel overlapping the inner panel to expose a previously overlapped region thereof; and
inspecting the previously overlapped region to detect scratches.

2. A method according to claim 1 wherein the step of inspecting comprises visually inspecting.

3. A method according to claim 1 further comprising repairing at least one scratch detected in the previously overlapped region.

4. A method according to claim 3 wherein the step of repairing comprises blending out the at least one scratch.

5. A method according to claim 1 further comprising testing the previously overlapped region to detect cracks.

6. A method according to claim 5 further comprising repairing at least one detected crack.

7. A method according to claim 6 wherein the step of repairing comprises:
removing a section of the previously overlapped region including the at least one detected crack; and
replacing the removed section with a replacement panel.

8. A method according to claim 7 wherein the step of replacing comprises substituting a replacement doubler for the removed section.

9. A method according to claim 5 wherein the step of testing comprises performing a high frequency eddy current inspection.

10. A method according to claim 1 wherein the step of trimming comprises cutting with a rotary trimming tool.

11. A method according to claim 10 wherein the step of trimming further comprises manually scraping away a residual portion of the outer skin panel not removed by the rotary cutting device.

12. A method according to claim 1 further comprising detecting at least a first scratch in the inner panel proximate the lap joint prior to trimming.

13. A method for detecting scratches and cracks proximate an aircraft fuselage lap joint formed where an outer skin panel overlaps an inner panel, the method comprising:
trimming a portion of the outer skin panel overlapping the inner panel to expose a previously overlapped region thereof;
inspecting the previously overlapped region to detect scratches; and
testing the previously overlapped region to detect cracks.

14. A method according to claim 13 further comprising blending out at least one detected scratch.

15. A method according to claim 13 furthering comprises repairing at least one detected crack.

16. A method according to claim 15 wherein the step of repairing at least one detected crack comprises:
removing a section of the previously overlapped region including the at least one detected crack; and
replacing the removed section with a replacement panel.

17. A method according to claim 16 wherein the step of replacing comprises substituting a replacement doubler for the removed section.

18. A method according to claim 13 wherein the step of inspecting comprises visually inspecting for scratches.

19. A method according to claim 13 wherein the step of testing comprises performing a high frequency eddy current inspection for cracks.

20. A method according to claim 13 wherein the step of trimming comprises cutting with a rotary trimming tool.

21. A method according to claim 13 further comprising detecting at least a first scratch in the inner panel proximate the lap joint prior to trimming.

22. A method for detecting and repairing scratches and cracks proximate an aircraft fuselage lap joint formed where an outer skin panel having an overlapping edge overlaps an inner panel, the method comprising:
finding at least a first scratch in the inner panel proximate the lap joint;
trimming a portion of the outer skin panel overlapping the inner panel including at least a portion of the overlapping edge to expose a previously overlapped region of the inner panel;
inspecting the previously overlapped region to detect scratches;
testing the previously overlapped region to detect cracks; and
repairing at least one detected crack.

23. A method according to claim 22 wherein the step of repairing at least one detected crack further comprises:
removing a section of the previously overlapped region including the at least one detected crack; and
replacing the removed section with a replacement panel.

24. A method according to claim 23 wherein the step of replacing comprises substituting a replacement doubler for the removed section.

25. A method according to claim 22 wherein the step of testing for cracks comprises performing a high frequency eddy current inspection.

26. A method according to claim 22 wherein the step of inspecting for scratches comprises visually inspecting.

27. A method according to claim 22 further comprising the step of repairing at least one detected scratch.

28. A method according to claim 27 wherein the step of repairing at least one detected scratch comprises blending out.

29. A method according to claim 22 wherein the trimmed portion of the outer skin panel is proximate the at least a first scratch found during the step of finding.

30. A method according to claim 22 wherein the step of trimming comprises cutting with a rotary trimming tool.
